(19) United States
(12) Patent Application Publication
(10) Pub. No.: US 2001/0030784 A1
(43) Pub. Date: Oct. 18, 2001

(54) Optical transmission system and optical transmission method using optical wavelength division multiplexing

(76) Inventor: Keiichi Urashita, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/832,091

(22) Filed: Apr. 11, 2001

(30) Foreign Application Priority Data
Apr. 13, 2000 (JP) 111577/2000

(51) Int. Cl. H04J 14/02; H04B 10/12

(52) U.S. Cl. 359/124; 359/173

(57) ABSTRACT

An optical transmission system is composed of an optical transmitter, an optical fiber and an optical receiver. An input optical signal having a first transmission rate is inputted to the optical transmitter. The optical transmitter includes a converter converting the input optical signal into a plurality of optical transmission signals having second transmission rate, and an optical multiplexer multiplexing the plurality of optical transmission signals into a multiplexed optical transmission signal. The optical fiber transmitting the multiplexed optical transmission signal. The optical receiver receiving the multiplexed optical transmission signal. The second transmission rate is smaller than the first transmission rate.

### BACKGROUND OF THE INVENTION

1. Field of the Invention

The present invention relates to an optical transmission system and a method of optical transmission. More particularly, the present invention relates to an optical transmission system and a method of optical transmission, using optical wavelength division multiplexing.

2. Description of the Related Art

In order to transmit many information, an optical wavelength division multiplexing technique is used. In an optical wavelength division multiplexing system, optical signals having different wavelengths different from each other are transmitted through one optical fiber. An optical wavelength division multiplexing system is disclosed in Japanese Laid Open Patent Application (JP-A-Showa, 62-292030). As shown in FIG. 1. , electric digital signals 102₁₁ to 102₁ₙ from transmission terminals 101₁₁ to 101₁ₙ are inputted to an electrical-optical converters 103₁. The electrical-optical converter 103₁ converts the electric digital signals 102₁₁ to 102₁ₙ into optical signals 104₁₁ to 104₁ₙ. Wavelengths of the optical signals 104₁₁ to 104₁ₙ are λ₁₁ to λ₁ₙ, respectively.

The optical signals 104₁₁ to 104₁ₙ are multiplexed into an optical transmission signal by an wavelength division multiplexer 105. The optical transmission signal is transmitted through an optical fiber 106. The optical transmission signal is separated into optical signals 108₁₁′ to 108₁ₙ′ by using an wavelength division demultiplexer 107. Wavelengths of the optical signals 108₁₁ to 108₁ₙ are λ₁₁ to λ₁ₙ′ respectively. The optical signals 108₁₁ to 108₁ₙ are inputted to an optical-electric converter 109₁. The optical-electric converter 109₁ converts the optical signals 108₁₁ to 108₁ₙ into electric digital signals 110₁₁ to 110₁ₙ. The digital signals 110₁₁ to 110₁ₙ arrive at reception terminals 111₁₁ to 111₁ₙ.

Also, electric digital signals 102₂₁ to 102₂ₙ from transmission terminals 101₂₁ to 101₂ₙ arrive at reception terminals 111₂₁ to 111₂ₙ in the same way.

The optical signal suffers from an influence caused by a disturbance at a time of the transmission through the optical fiber. When the optical signal is transmitted through the optical fiber, an optical attenuation induced in the optical fiber, an optical dispersion phenomenon and a non-linearly optical effect result in the disturbance, which brings about the deterioration in the optical signal. Moreover, other factors besides them may result in the disturbance.

The optical transmission system desirably has the strong durability against the disturbance.

Moreover, the optical transmission system desirably has a long transmission distance.

Another optical transmission system having basically the same architecture is disclosed in Japanese Laid Open Patent Application (Jp-A-Heisei 11-331132).

Still another optical transmission system which may be related to the present invention is disclosed in Japanese Laid Open Patent Application (Jp-A-Heisei 1-144832). In the other optical transmission system, a synchronization optical signal and a data optical signal having different wavelengths are multiplexed and are transmitted.

### SUMMARY OF THE INVENTION

Therefore, an object of the present invention is to provide an optical transmission system having a strong durability against a disturbance.

Another object of the present invention is to provide an optical transmission system having a long transmission distance.

In order to achieve an aspect of the present invention, an optical transmission system is composed of an optical transmitter, an optical fiber and an optical receiver. An input optical signal having a first transmission rate is inputted to the optical transmitter. The optical transmitter includes a converter converting the input optical signal into a plurality of optical transmission signals having second transmission rate, and an optical multiplexer multiplexing the plurality of optical transmission signals into a multiplexed optical transmission signal. The optical fiber transmitting the multiplexed optical transmission signal. The optical receiver receiving the multiplexed optical transmission signal. The second transmission rate is smaller than the first transmission rate.

Generally, the durability against the disturbance is increased as the transmission rate is small. The smaller second transmission rate improve the durability against the disturbance. Also, this results in long transmission distance.

Desirably, it holes

n≧s₁/s₂,

where s₁ is the first transmission rate, and s₂ is the second transmission rate, and n is a number of the plurality of optical transmission signals. In this case, the effective transmission rate of the optical transmission system is not reduced.

More desirably, number of the optical transmission signals is substantially equal to s₁/s₂, where s₁ is the first transmission rate, and s₂ is the second transmission rate.

The plurality of optical transmission signals desirably have different wavelengths from each other.

The converter is desirably composed of a transmitting side optical-electrical converter, a divider, and a transmitting side electrical-optical converter. The transmitting side optical-electrical converter converts the optical input signal into a first electrical signal. The divider divides the first electrical signal into a plurality of second electrical signals. The transmitting side electrical-optical converter respectively converts the plurality of second electrical signals into the plurality of optical transmission signals.

The direct conversion of the optical input signal into the plurality of the optical transmission signal may be technically difficult. The electrical signal processing is generally easier than the optical signal processing. The conversion of the optical input signal into the first electrical signal facilitates the signal processing.

The optical receiver may convert the multiplexed optical transmission signal into an optical output signal substantially identical to the optical input signal to output the optical output signal.

In this case, the optical receiver includes a demultiplexer, receiving side optical-electrical converter, an electrical multiplexer, and a receiving side electrical-optical converter. The demultiplexer demultiplexes the multiplexed optical transmission signal. The receiving side optical-electrical converter respectively converts the plurality of transmitted optical transmission signal into a plurality of third electrical signals. The electrical multiplexer multiplexes the plurality of third electrical signals into a fourth electrical signal. The receiving side electrical-optical converter converts the fourth electrical signal into the optical output signal.

In this case, the electrical multiplexer is desirably composed of a storage unit and a combining unit. The storage unit stores a plurality of data respectively transmitted over the plurality of third electrical signals and outputs a plurality of fifth electrical signals respectively indicative of the plurality of data at predetermined timing. The combining unit combines the plurality of fifth electrical signals to generate the fourth electrical signal.

In order to achieve another aspect of the present invention, an optical transmitter is composed of a converter, and an optical multiplexer. An input optical signal having a first transmission rate is inputted to the converter. The converter converts the input optical signal into a plurality of optical transmission signals having second transmission rate. The optical multiplexer multiplexes the plurality of optical transmission signals into a multiplexed optical transmission signal. The second transmission rate is smaller than the first transmission rate.

In order to achieve still another aspect of the present invention, an optical receiver is composed of a demultiplexer and a converting unit. The demultiplexer demultiplexes a multiplexed optical transmission signal into a plurality of optical transmission signals. Transmission rates of the plurality of optical transmission signals are substantially equal to a second transmission rate. The converting unit converts the plurality of optical transmission signals into a optical output signal having a first transmission rate. The second transmission rate is smaller than the first transmission rate.

In order to achieve still another aspect of the present invention, an optical transmission method is composed of:

inputting an input optical signal having a first transmission;

converting the input optical signal into a plurality of optical transmission signals having second transmission rate;

multiplexing the plurality of optical transmission signals into a multiplexed optical transmission signal;

transmitting the multiplexed optical transmission signal over an optical fiber; and

receiving the multiplexed optical transmission signal, wherein the second transmission rate is smaller than the first transmission rate.

In order to achieve still another aspect of the present invention, an operating method of an optical transmitter is composed of:

inputting an input optical signal having a first transmission;

converting the input optical signal into a plurality of optical transmission signals having second transmission rate;

multiplexing the plurality of optical transmission signals into a multiplexed optical transmission signal, wherein the second transmission rate is smaller than the first transmission rate.

In order to achieve still another aspect of the present invention, an operating method of an optical receiver is composed of:

receiving a multiplexed optical transmission signal from a optical fiber;

demultiplexing the multiplexed optical transmission signal into a plurality of transmitted optical signals, wherein transmission rates of the plurality of transmitted optical signals are substantially equal to a second transmission rate; and

converting the plurality of transmitted optical signals into an optical output signal having first transmission rate, wherein the second transmission rate is smaller than the first transmission rate.

### BRIEF DESCRIPTION OF THE DRAWINGS

FIG. 1 shows a conventional optical transmission system using wavelength division multiplexing;

FIG. 2 shows a configuration of an optical transmission system of an embodiment according to the present invention; and

FIG. 3 shows a course in which SONET/SDH frames #1 to #25 are sent by the optical transmission system.

### DESCRIPTION OF THE PREFERRED EMBODIMENTS

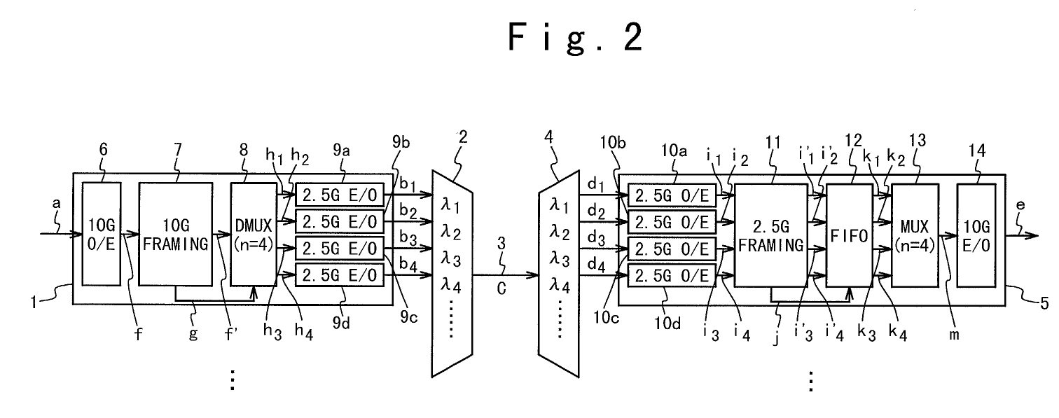

With reference to the attached drawings, a dividing unit is provided with a wavelength division multiplexer (hereafter, referred to as a WDM). The dividing unit 1 is connected to a WDM 2, as shown in FIG. 2.

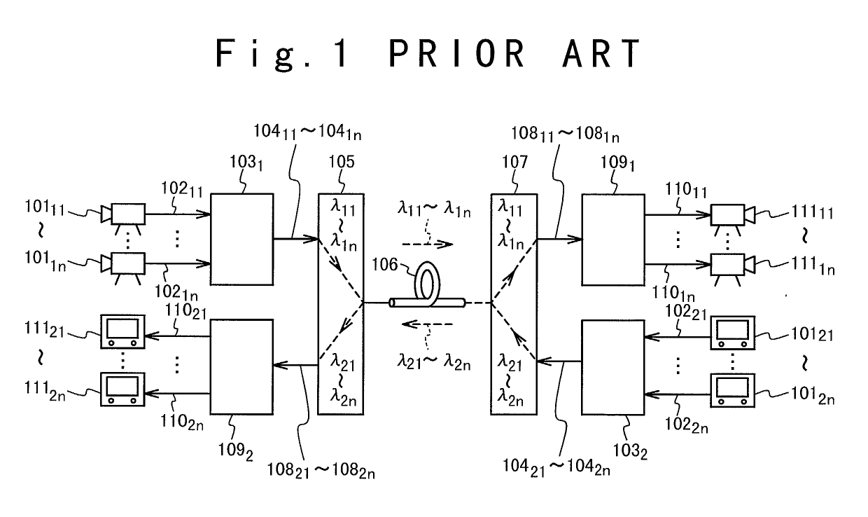

An optical input signal a is inputted to the dividing unit 1. A transmission rate of the optical input signal a is 10 (Gbit/s). The dividing unit 1 converts the optical input signal a into four optical signals b₁ to b₄. Transmission rates of the optical signals b₁ to b₄ are approximately 2.5 (Gbit/s). Wavelengths of the optical signals b₁ to b₄ are λ₁, λ₂, λ₃ and λ₄, respectively. The wavelengths λ₁, λ₂, λ₃ and λ₄ are different from each other. Here, a plurality of dividing units 1 may be connected to the WDM 2. FIG. 1 shows only one of the plurality of dividing units 1.

The WDM 2 multiplexes the 2.5-G optical signals b₁ to b₄ to generates a WDM signal c. The WDM 2 outputs the WDM signal c to an optical fiber 3. The optical fiber 3 transmits the WDM signal c to a wavelength division demultiplexer (referred as WDD, hereinafter) 4. Transmission rate of the WDM signal c is approximately 2.5 (Gbit/s).

The WDD 4 demultiplexes the WDM signal c into 2.5-G optical signals d₁ to d₄. The 2.5-G optical signals d₁ to d₄ are substantially identical to the 2.5-G optical signals b₁ to b₄, respectively. The WDD 4 outputs the 2.5-G optical signals d₁ to d₄ to a multiplexing unit 5.

The multiplexing unit 5 integrates the 2.5-G optical signals d₁ to d₄ into one optical output signal e. The optical output signal e is substantially identical to the optical input signal a. In this case, when a plurality of dividing units 1 are mounted, one multiplexing unit 5 is mounted correspondingly to each of the plurality of dividing units 1. FIG. 1 shows only one of the plurality of the multiplexing unit 5.

The configuration of the dividing unit 1 is described below in detail. The dividing unit 1 includes a 10-G optical/electrical converter 6. The optical input signal a is inputted to the 10-G optical/electrical converter 6. As mentioned above, the transmission rate of the optical input signal a is 10 (Gbit/s). A plurality of SONET/SDH frames are sequentially sent by the optical input signal a. The SONET/SDH frames respectively have framing bytes indicative of the heads of the SONET/SDH frames.

The 10-G optical/electrical converter 6 converts the optical input signal a into an electric signal f to output to a 10-G frame synthesizer 7. The 10-G frame synthesizer 7 detects the framing bytes included in the input electric signal f to generates a synchronous signal g indicative of a timing synchronous with each of the SONET/SDH frames. The 10-G frame synthesizer 7 further generates an electric signal f′ substantially identical to the electric signal f. The 10-G frame synthesizer 7 outputs the electric signal f′ and the synchronous signal g to a divider 8. The divider 8 fetches the SONET/SDH frames from the electric signal f′ in synchronization with the synchronous signal g.

The divider 8 outputs a first input SONET/SDH frame after a start of an input of the electric signal f′ to a 2.5-G electrical/optical converter 9a over a frame signal h₁. The divider 8 outputs a next input SONET/SDH frame to a 2.5-G electrical/optical converter 9b over a frame signal h₂. The divider 8 outputs a next input SONET/SDH frame to a 2.5-G electrical/optical converter 9c as a frame signal h₃. The divider 8 outputs a further next input SONET/SDH frame to a 2.5-G electrical/optical converter 9c as a frame signal h4. After that, when a SONET/SDH frame is further inputted, the SONET/SDH frame is sequentially outputted to the 2.5-G electrical/optical converters 9a to 9d in accordance with the above-mentioned processes. As mentioned above, the divider 8 sequentially outputs the input SONET/SDH frames to the 2.5-G electrical/optical converters 9a to 9d.

The 2.5-G electrical/optical converters 9a to 9d respectively convert the frame signal h₁ to h₄ into the 2.5-G optical signals b₁ to b₄, respectively. All of the transmission rates of the 2.5-G optical signals b₁ to b₄ are approximately 2.5 (Gbit/s). The 2.5-G electrical/optical converters 9a to 9d outputs the 2.5-G optical signals b₁ to b₄ to the WDM 2, respectively. As mentioned above the WDM 2 multiplexes the 2.5-G optical signals b₁ to b₄ into the WDM signal c.

The configuration of the multiplexing unit 5 will be described below in detail. The multiplexing unit 5 includes 2.5-G optical/electrical converters 10a to 10d. The 2.5-G optical/electrical converters 10a to 10d respectively receive the 2.5-G optical signals d₁ to d₄ from the WDD 4, which demultiplexes the WDM signal c. The 2.5-G optical/electrical converters 10a to 10d convert the 2.5-G optical signals d₁ to d₄ into electric signals i₁ to i₄, respectively. The 2.5-G optical/electrical converters 10a to 10d output the electric signals i₁ to i₄ to a 2.5-G frame synthesizer 11.

The 2.5-G frame synthesizer 11 detects the framing bytes included in the electric signals i₁ to i₄ to generate a synchronous signal j indicative of a timing synchronous with each of the SONET/SDH frames sent through the electric signals i₁ to i₄. The 2.5-G frame synthesizer 11 further generates electric signals i₁′ to i₄′ substantially identical to the electric signals i₁ to i₄. The 2.5-G frame synthesizer 11 outputs the electric signals i₁′ to i₄′ and the synchronous signal j to an FIFO 12.

The FIFO 12 accumulates the respective SONET/SDH frames sent through the electric signals i₁′ to i₄′ while carrying out the synchronization between them on the basis of the synchronous signal j. The FIFO 12 outputs the respective SONET/SDH frames in the input order, at a predetermined timing.

The reason of the installation of the FIFO 12 is as follows. As mentioned above, the 2.5-G optical signals b₁ to b₄, multiplexed into the WDM signal c, have the wavelengths different from each other. When the 2.5-G optical signals b₁ to b₄ multiplexed into the WDM signal c are transmitted through the optical fiber 3, transmission delay times in the optical fiber 3 is different depending on the wavelengths because of the optical dispersion phenomenon in the optical fiber 3. This causes the transmission rates of the 2.5-G optical signal b₁ to b₄ in the WDM signal c to be slightly different from each other. The electric signals i₁′ to i₄′ outputted from the 2.5-G frame synthesizer 11 are also slightly out of timing, correspondingly to the difference of the delay times of the 2.5-G optical signal b₁ to b4. Therefore, the respective SONET/SDH frames sent through the electric signals i₁′ to i₄′ are once accumulated in the FIFO 12. Then, the SONET/SDH frames are outputted from the FIFO 12 at the predetermined timing. In this way, the difference of the delay times of the 2.5-G optical signal b₁ to b₄ in the WDM signal c is absorbed.

The FIFO 12 outputs the SONET/SDH frames transmitted through the electric signal i₁′ to a multiplexer 13 by an electric signal k₁ in the input order. Similarly, the FIFO 12 outputs the SONET/SDH frames transmitted through the electric signals i₂ to i₄ to the multiplexer 13 by electric signals k₂ to k₄ in the input order.

The timing when the FIFO 12 outputs the SONET/SDH frame is not limited to the certain temporal interval. The timing when the FIFO 12 outputs the SONET/SDH frame may be a predetermined timing other than the certain temporal interval, at which the difference of the delay times of the 2.5-G optical signal b₁ to b₄ is absorbed.

The multiplexer 13 couples the respective SONET/SDH frames transmitted through the electric signals k₁ to k₄ in the input order to generate the electric signal m. The multiplexer 13 outputs the electric signal m to a 10-G electric/optical converter 14. A transmission rate of the electric signal m is 10 (Gbit/s). The 10-G electric/optical converter 14 converts the electric signal m into the optical output signal e to output it. The transmission rate of the optical output signal e is 10 (Gbit/s) as mentioned above.

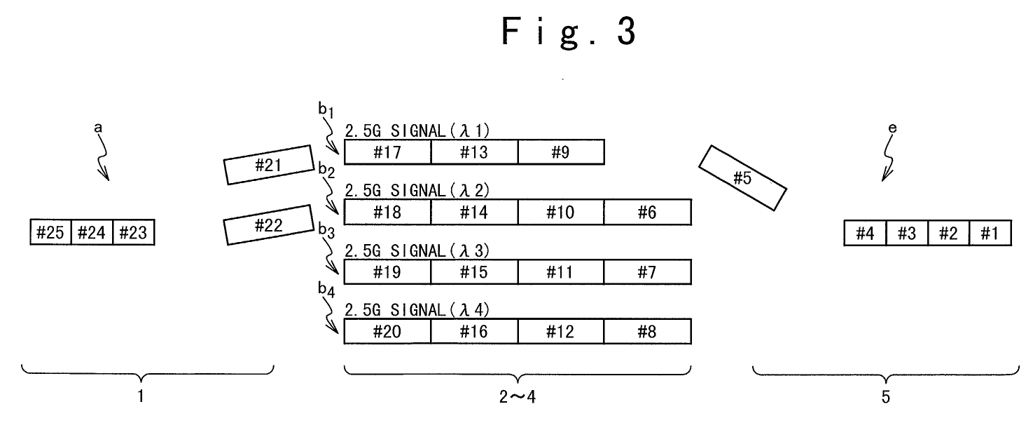

FIG. 3 shows a course in which SONET/SDH frames #1 to #25, inputted to the dividing unit 1, are sent to the multiplexing unit 5 by the optical transmission system. FIG. 3 shows the momentary states of the SONET/SDH frames #1 to #25 immediately before the #5 is sent to the multiplexing unit 5 after the frames #1 to #4 are already sent to the multiplexing unit 5.

The SONET/SDH frames #1 to #25 are inputted to the dividing unit 1 in the order of the ascending number. The SONET/SDH frame #1 is converted into the 2.5-G optical signals b₁ having a wavelength of λ₁, and then sent to the multiplexing unit 5. Similarly, the SONET/SDH frames #2 to #4 are converted into the 2.5-G optical signals b₂ to b₄ having wavelengths of λ₂ to λ₄, respectively, and then sent to the multiplexing unit 5.

FIG. 3 shows the SONET/SDH frames #1 to #4 are outputted as the optical output signal e in the order of the SONET/SDH frames #1, #2, #3 and #4.

Also, FIG. 3 shows the SONET/SDH frames #5, #9, #13 and #17 are converted into the 2.5-G optical signals b₁ having a wavelength are λ₁, and they are being sent to the multiplexing unit 5. The SONET/SDH frames #6, #10, #14 and #18 are converted into the 2.5-G optical signals b₂ having the wavelength are λ₂, and they are being sent to the multiplexing unit 5. The SONET/SDH frames #7, #11, #15 and #19 are converted into the 2.5-G optical signals b₃ having the wavelength of λ₃, and they are being sent to the multiplexing unit 5. The SONET/SDH frames #5, #9, #13 and #17 are converted into the 2.5-G optical signals b₁ having the wavelength are λ₁, and they are being sent to the multiplexing unit 5.

In addition, FIG. 3 shows the SONET/SDH frame #21 is being converted into the 2.5-G optical signals b₁. Moreover, FIG. 3 shows the fact that the SONET/SDH frame #22 is being converted into the 2.5-G optical signals b₂.

Furthermore, FIG. 3 shows the SONET/SDH frames #23 to #25 are inputted to the dividing unit 1 after the SONET/SDH frame #22. The SONET/SDH frames #23, #24 and #25 are transmitted through the 2.5-G optical signals b₃, b₄ and b₁ respectively having wavelengths of λ₃, λ₄ and λ₁, after the moment shown in FIG. 3.

As mentioned above, the SONET/SDH frames #1 to #25 are sequentially inputted through the optical input signal a to the dividing unit 1 of the optical transmission system in this embodiment. The transmission rate of the optical input signal a is 10-Gb/s. The SONET/SDH frame #(4p₁+1) is converted into the 2.5-G optical signals b₁ having wavelength of λ₁, and sent to the multiplexing unit 5. Here, the p₁ is the integer between 0 and 6. Also, the SONET/SDH frame #(4p₂+2) is converted into the 2.5-G optical signals b₂ having wavelength of λ₂, and sent to the multiplexing unit 5. Here, the p2 is the integer between 0 and 5. Moreover, the SONET/SDH frame #(4p₃+3) is converted into the 2.5-G optical signals b₃ having wavelength of λ₃ , and sent to the multiplexing unit 5. Here, the p₃ is the integer between 0 and 5. Moreover, the SONET/SDH frame #(4p₄+4) is converted into the 2.5-G optical signals b₄ having wavelength of λ₄, and sent to the multiplexing unit 5. Here, the p₄ is the integer between 0 and 5. All of the transmission rates of the 2.5-G optical signals b₁ to b₄ having wavelength of λ₂ are approximately 2.5 (Gbits ). The multiplexing unit 5 sequentially outputs the SONET/SDH frames #1 to #25 as the optical output signal e having the transmission rate of 10 (Gbit/s).

In the embodiments, the transmission rate of the optical input signal a is not limited to 10 (Gbit/s). Also, the transmission rates of the 2.5-G optical signals b₁ to b₄ are not approximately limited to 2.5 (Gbit/s) if they are lower than that of the optical input signal a. Moreover, the number of the 2.5-G optical signals b₁ to b₄ are not limited to four if they are at least plural.

However, it desirably holds:

n≧s₁/s₂

where s₁ is the transmission rate of the optical input signal a, s₂ is the transmission rates of the 2.5-G optical signals b₁ to b₄, n is the number of the 2.5-G optical signals b₁ to b₄ is n. This is because the data inputted through the optical input signal a can be sent without any drop in the effective transmission rate.

In particular, n is desired to be substantially equal to s₁/s₂. This is because the circuit for converting the optical input signal a into the WDM signal c and the circuit for converting the WDM signal c into an optical output signal e can be reduced to the necessary minimum.

The present invention provides the optical transmission system having the high durability against the disturbance.

Moreover, the present invention provides the optical transmission system having the long transmission distance.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. An optical transmission system comprising:
an optical transmitter to which an input optical signal having a first transmission rate is inputted, wherein said optical transmitter includes:
a converter converting said input optical signal into a plurality of optical transmission signals having second transmission rate, and
an optical multiplexer multiplexing said plurality of optical transmission signals into a multiplexed optical transmission signal;
an optical fiber transmitting said multiplexed optical transmission signal; and
an optical receiver receiving said multiplexed optical transmission signal, wherein said second transmission rate is smaller than said first transmission rate.

2. The optical transmission system according to claim 1, wherein
n≧s₁/s₂,
where s₁ is said first transmission rate, and s₂ is said second transmission rate, and n is a number of said plurality of optical transmission signals.

3. The optical transmission system according to claim 1, wherein a number of said optical transmission signals is substantially equal to s₁/s₂, where s₁ is said first transmission rate, and s₂ is said second transmission rate.

4. The optical transmission system according to claim 1, wherein said plurality of optical transmission signals have different wavelengths from each other.

5. The optical transmission system according to claim 1, wherein said converter comprises:
a transmitting side optical-electrical converter converting said optical input signal into a first electrical signal;
a divider dividing said first electrical signal into a plurality of second electrical signals; and
a transmitting side electrical-optical converter respectively converting said plurality of second electrical signals into said plurality of optical transmission signals.

6. The optical transmission system according to claim 1, wherein said optical receiver converts said multiplexed optical transmission signal into an optical output signal substantially identical to said optical input signal to output said optical output signal.

7. The optical transmission system according to claim 6, wherein said optical receiver includes:
a demultiplexer demultiplexing said multiplexed optical transmission signal,
a receiving side optical-electrical converter respectively converting said plurality of transmitted optical transmission signal into a plurality of third electrical signals,
an electrical multiplexer multiplexing said plurality of third electrical signals into a fourth electrical signal, and
a receiving side electrical-optical converter converting said fourth electrical signal into said optical output signal.

8. The optical transmission system according to claim 7, wherein said electrical multiplexer comprises:
a storage unit storing a plurality of data respectively transmitted over said plurality of third electrical signals and outputting a plurality of fifth electrical signals respectively indicative of said plurality of data at predetermined timing; and
a combining unit combining said plurality of fifth electrical signals to generate said fourth electrical signal.

9. An optical transmitter comprising:
a converter to which an input optical signal having a first transmission rate is inputted, wherein said converter converts said input optical signal into a plurality of optical transmission signals having second transmission rate; and
an optical multiplexer multiplexing said plurality of optical transmission signals into a multiplexed optical transmission signal, wherein said second transmission rate is smaller than said first transmission rate.

10. The optical transmitter according to claim 9, wherein
n≧s₁/s₂,
where s₁ is said first transmission rate, and s₂ is said second transmission rate, and n is a number of said optical transmission signals.

11. The optical transmitter according to claim 9, wherein a number of said plurality of optical transmission signals is substantially equal to s₁/s₂, where s₁ is said first transmission rate, and s₂ is said second transmission rate.

12. The optical transmitter according to claim 9, wherein said plurality of optical transmission signals have different wavelengths each other.

13. The optical transmitter according to claim 9, wherein said converter includes:
a transmitting side optical-electrical converter converting said optical input signal into a first electrical signal;
a divider dividing said first electrical signal into a plurality of second electrical signals; and
a transmitting side electrical-optical converter respectively converting said plurality of second electrical signals into said plurality of optical transmission signals.

14. An optical receiver comprising:
a demultiplexer demultiplexing a multiplexed optical transmission signal into a plurality of optical transmission signals, wherein transmission rates of said plurality of optical transmission signals are substantially equal to a second transmission rate; and
a converting unit converting said plurality of optical transmission signals into a optical output signal having a first transmission rate, wherein said second transmission rate is smaller than said first transmission rate.

15. The optical receiver according to claim 14, wherein
n≧s₁/s₂,
where s₁ is said first transmission rate, and s₂ is said second transmission rate, and n is a number of said optical transmission signals.

16. The optical receiver according to claim 14, wherein a number of said optical transmission signals is substantially equal to s₁/s₂, where s₁ is said first transmission rate, and s₂ is said second transmission rate.

17. The optical receiver according to claim 14, wherein said plurality of optical transmission signals have different wavelengths each other.

18. The optical receiver according to claim 14, wherein said converting unit includes:
a receiving side optical-electrical converter respectively converting said plurality of optical transmission signal into a plurality of third electrical signals,
an electrical multiplexer multiplexing said plurality of third electrical signals into a fourth electrical signal, and
a receiving side electrical-optical converter converting said fourth electrical signal into said optical output signal.

19. The optical receiver according to claim 14, wherein said electrical multiplexer comprises:
a storage unit storing a plurality of data respectively transmitted over said plurality of third electrical signals and outputting a plurality of fifth electrical signals respectively indicative of said plurality of data at predetermined timing; and
a combining unit combining said plurality of fifth electrical signals to generate said fourth electrical signal.

20. An optical transmission method comprising:
inputting an input optical signal having a first transmission;
converting said input optical signal into a plurality of optical transmission signals having second transmission rate;
multiplexing said plurality of optical transmission signals into a multiplexed optical transmission signal;
transmitting said multiplexed optical transmission signal over an optical fiber; and
receiving said multiplexed optical transmission signal, wherein said second transmission rate is smaller than said first transmission rate.

21. The optical transmission method according to claim 20, wherein
n≧s₁/s₂,
where s₁ is said first transmission rate, and s₂ is said second transmission rate, and n is a number of said plurality of optical transmission signals.

22. The optical transmission method according to claim 20, wherein a number of said optical transmission signals is substantially equal to s₁/s₂, where s₁ is said first transmission rate, and s₂ is said second transmission rate.

23. The optical transmission method according to claim 20, wherein said plurality of optical transmission signals have different wavelengths from each other.

24. The optical transmission method according to claim 20, wherein said converting includes:
converting said optical input signal into a first electrical signal;
dividing said first electrical signal into a plurality of second electrical signals; and
respectively converting said plurality of second electrical signals into said plurality of optical transmission signals.

25. The optical transmission method according to claim 20, wherein said receiving includes converting said multiplexed optical transmission signal into an optical output signal substantially identical to said optical input signal to output said optical output signal.

26. The optical transmission method according to claim 25, wherein said converting said multiplexed optical transmission signal comprises:
demultiplexing said multiplexed optical transmission signal into a plurality of transmitted optical signals;
respectively converting said plurality of transmitted optical signal into a plurality of third electrical signals;
multiplexing said plurality of third electrical signals into a fourth electrical signal; and
converting said fourth electrical signal into said optical output signal.

27. The optical transmission method according to claim 26, wherein said multiplexing said plurality of third electrical signals includes:
storing a plurality of data respectively transmitted over said plurality of third electrical signals,
outputting a plurality of fifth electrical signals respectively indicative of said plurality of data at predetermined timing, and
combining said plurality of fifth electrical signals to generate said fourth electrical signal.

28. An operating method of an optical transmitter comprising:
inputting an input optical signal having a first transmission;
converting said input optical signal into a plurality of optical transmission signals having second transmission rate;
multiplexing said plurality of optical transmission signals into a multiplexed optical transmission signal, wherein said second transmission rate is smaller than said first transmission rate.

29. An operating method of an optical receiver comprising:
receiving a multiplexed optical transmission signal from a optical fiber;
demultiplexing said multiplexed optical transmission signal into a plurality of transmitted optical signals, wherein transmission rates of said plurality of transmitted optical signals are substantially equal to a second transmission rate; and
converting said plurality of transmitted optical signals into an optical output signal having first transmission rate, wherein said second transmission rate is smaller than said first transmission rate.
